(19) United States
(12) Patent Application Publication
(10) Pub. No.: US 2009/0310236 A1
(43) Pub. Date: Dec. 17, 2009

(54) LENS MODULE

(75) Inventor: CHENG-SHIUN WU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/327,534

(22) Filed: Dec. 3, 2008

(30) Foreign Application Priority Data
Jun. 12, 2008 (CN) 200810302109.5

(51) Int. Cl. G02B 7/02

(52) U.S. Cl. 359/820

(57) ABSTRACT

An exemplary lens module includes a barrel, a lens received in the barrel, and a generally C-shaped fastening member rotatably received in the barrel. The barrel includes an inner surface and a protrusion formed on the inner surface thereof. The fastening member is sandwiched between the lens and the protrusion. The fastening member has a gap defined between two distal ends thereof. The protrusion is passable through the gap. The fastening member is rotatable in the barrel relative to the protrusion such that the gap is misaligned with the protrusion.

### BACKGROUND

1. Technical Field

The present invention relates imaging technology, and particularly to a lens module.

2. Description of Related Art

A typical lens module 20 is shown in FIG. 8. The lens module 20 includes a barrel 202 and a plurality of optical elements received in the barrel 202. The optical elements includes a first lens 204, a light blocking plate 210, a second lens 206, a spacer 212 and a third lens 208. The lens module 20 has an optical axis. The barrel 202 includes a supporting portion 2022. Generally, the optical elements are mounted in the barrel 202 via an adhesive.

However, when the optical elements are not well fixed in the barrel 202, or the adhering ability of the adhesive deteriorates, the structure of the lens module 20 may be prone to unstable. Referring to FIG. 9, when the lens module 20 is heated, the optical elements may expand. Because the first lens 204 is in contact with the supporting portion 2022 of the barrel 202, the optical elements may expand along the optical axis 214 in a direction away from the supporting portion 2022. As a result, the imaging quality of the lens module 20 is weakened.

Therefore, a new lens module is desired to overcome the above mentioned problems.

### SUMMARY

An exemplary lens module includes a barrel, a lens received in the barrel, and a generally C-shaped fastening member rotatably received in the barrel. The barrel includes an inner surface and a protrusion formed on the inner surface thereof. The fastening member is sandwiched between the lens and the protrusion. The fastening member has a gap defined between two distal ends thereof. The protrusion is passable through the gap. The fastening member is rotatable in the barrel relative to the protrusion such that the gap is misaligned with the protrusion.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a perspective view of a lens module according to a first embodiment.

FIG. 2 is a side, cross-sectional view of the lens module of FIG. 1, taken along the line II-II thereof.

FIG. 3 is a perspective view of a barrel of the lens module depicted in FIG. 1.

FIG. 4 is a perspective view of a fastening member of the lens module depicted in FIG. 1.

FIG. 5 is a perspective view of the lens module of FIG. 1 in a first state during assembly.

FIG. 6 is a perspective view of the lens module of FIG. 1 in a second state during assembly.

FIG. 7 is a perspective view of a lens module according to a second embodiment.

FIG. 8 is a side, cross-sectional view of a typical lens module.

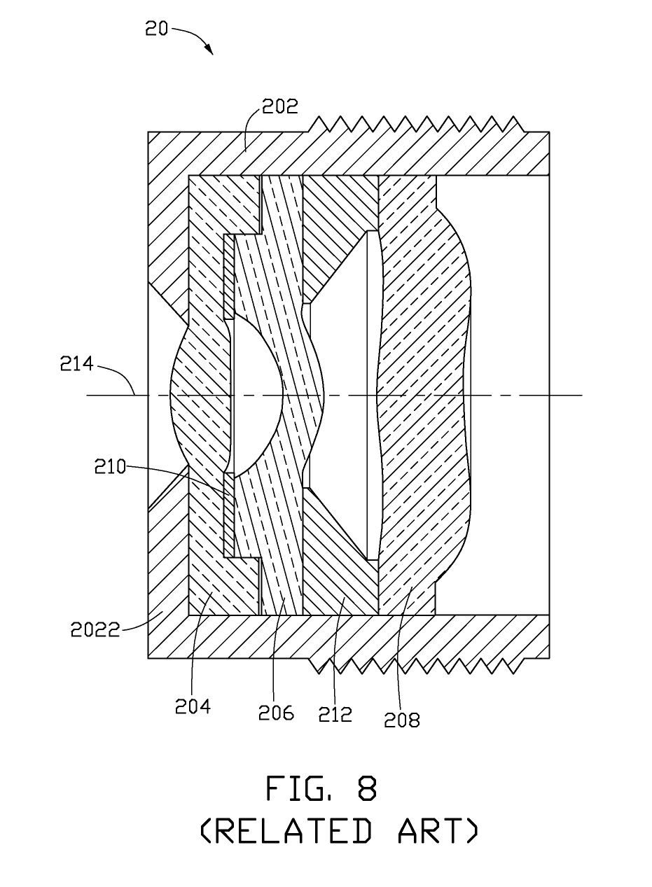

FIG. 9 is a side, cross-sectional view of the lens module when optical elements are heated and expand.

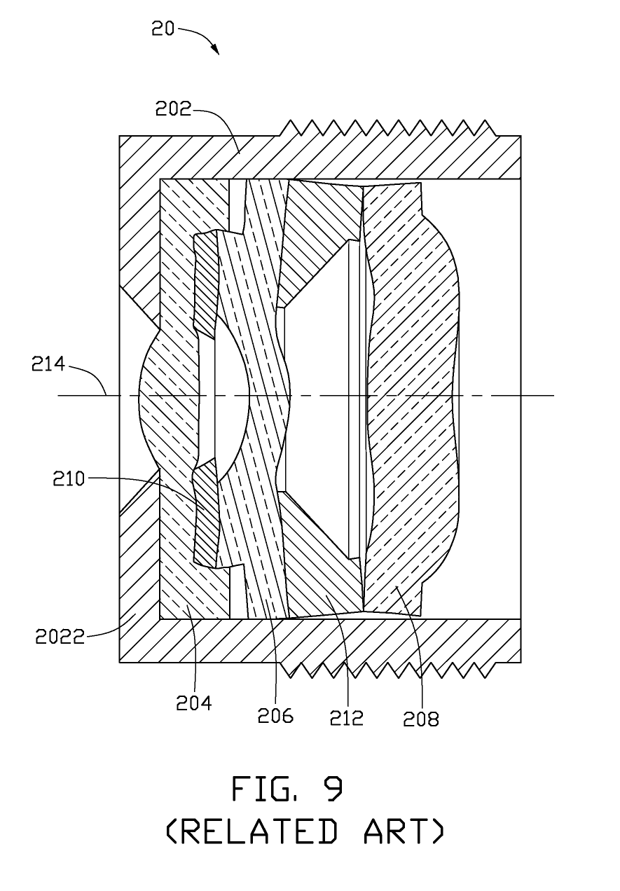

### DETAILED DESCRIPTION OF THE EMBODIMENTS

Embodiments will now be described in detail below with reference to the drawings.

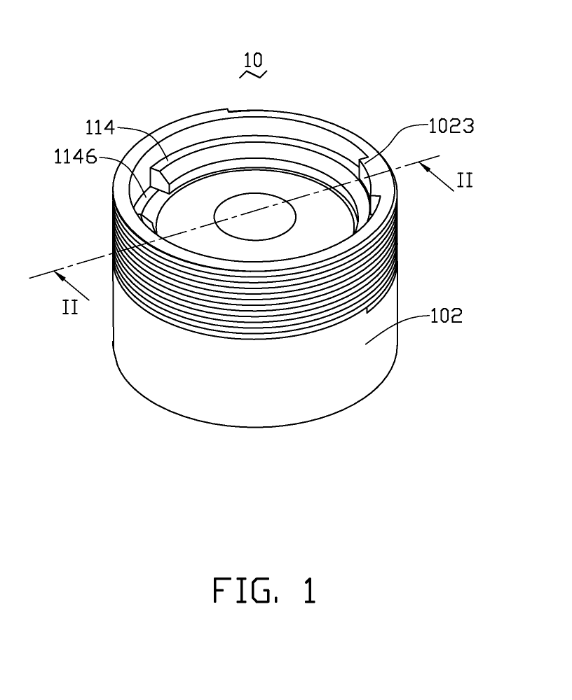

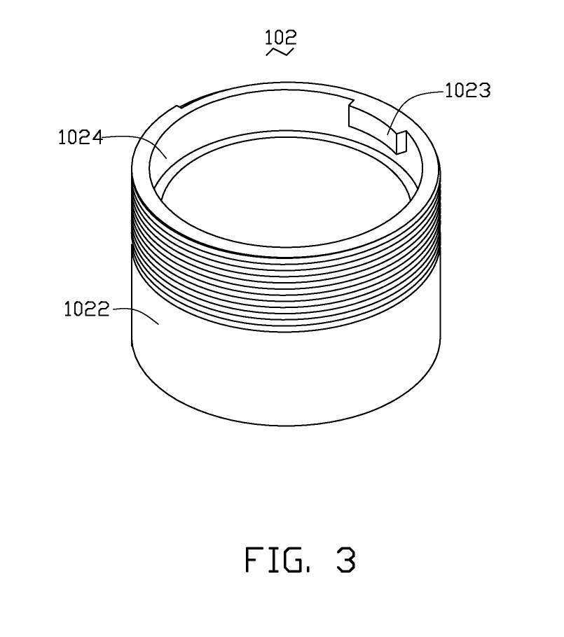

Referring to FIGS. 1-3, a lens module 10 includes a barrel 102, a lens unit received in the barrel 102, and a fastening member 114 rotatably received in the barrel 102. The lens unit includes a first lens 104, a light blocking plate 110, a second lens 106, a spacer 112, and a third lens 108, in the order written from the object side to the image side. The lens unit has an optical axis 116.

The barrel 102 includes a first part 1022 and a second part 1024 connected with the first part 1022. The first part 1022 has a supporting portion 1021 at one end thereof. The supporting portion 1021 has a through hole 1028 defined at the center thereof so that light can go into the barrel 102 from outside. The second part 1024 includes a protrusion 1023 formed on the inner surface thereof. The protrusion 1023 is configured for fastening the fastening member 114 to the barrel 102. The first lens 104 is in contact with the supporting portion 1021. The first, the second and the third lenses 104, 106, 108 cooperate to form an image.

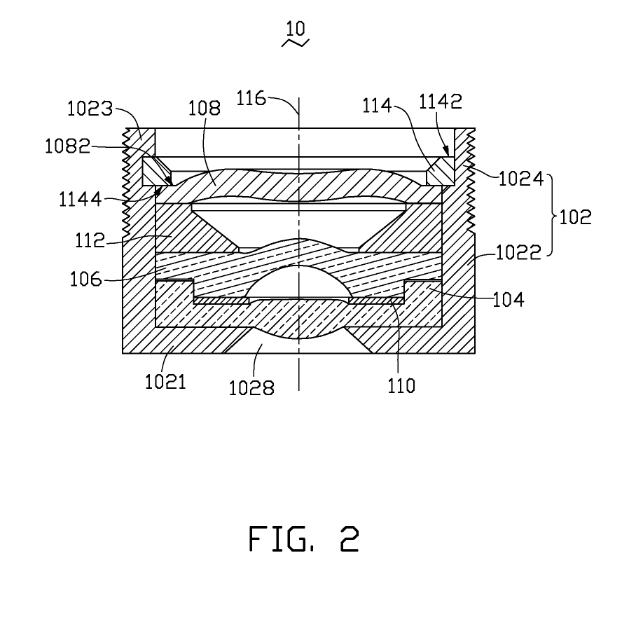

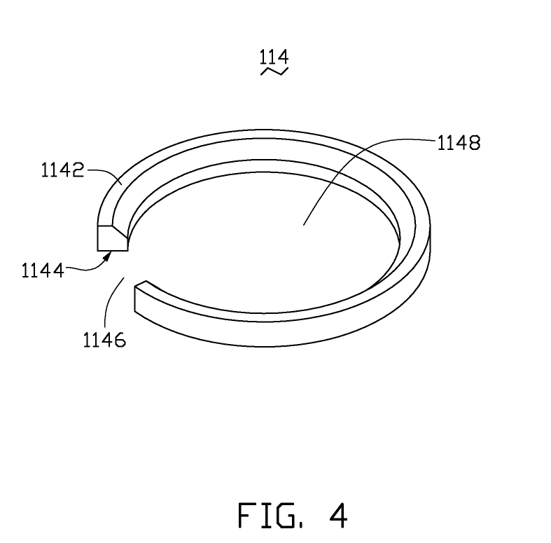

Referring to FIG. 4, the fastening member 114 is a discontinuous ring with a gap 1146 defined between two distal ends thereof. The fastening member 114 is generally C-shaped. The shape and the size of the gap 1146 match with the protrusion 1023 so that the protrusion is passable through the gap 1146. The size of the gap can be larger than or equal to that of the protrusion 1023. The fastening member 114 includes a through hole 1148 defined at the center thereof. The fastening member 114 includes a top surface 1142 and an opposite bottom surface 1144. The bottom surface 1144 is in contact with the surface 1082 of the third lens 108, and the top surface 1142 is in contact with the protrusion 1023. The fastening member 114 is configured for fastening the lens unit (i.e., the first, the second and the third lenses 104, 106, 108) to the supporting portion 1021 of the barrel 102 (see FIGS. 1 and 2). The fastening member 114 can be further fixed in the barrel 102 via an adhesive. The fastening member 114 can be made of plastic or metal.

When the lens module 10 is heated, the fastening member 114 can reduce or eliminate the expansion of the optical elements along the optical axis 116 because the fastening member 114 is blocked by the protrusion 1023. Accordingly, the structure of the lens module 10 is more stable, and the imaging quality of the lens module 10 is improved.

A method for assembling the lens module 10 includes the following steps:

First, the first lens 104, the light blocking plate 110, the second lens 106, the spacer 112 and the third lens 108 are sequentially assembled into the barrel 102 in such a manner that the first lens 104 is in contact with the supporting portion 1021.

Second, an adhesive is applied between the sidewall of the third lens 108 and the barrel 102.

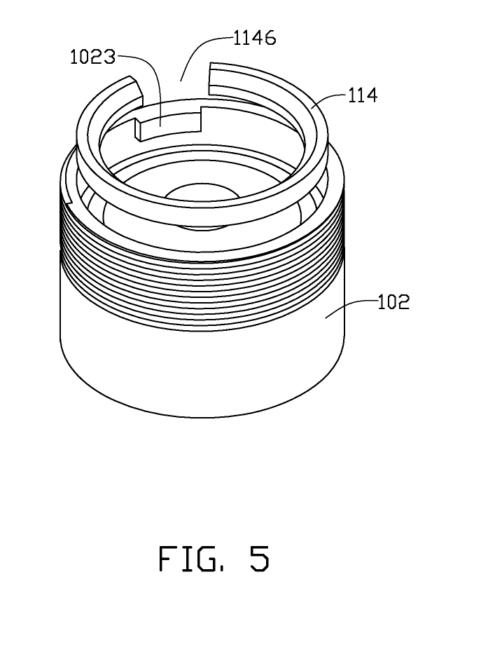

Third, referring to FIG. 5, the gap 1146 of the fastening member 114 is aligned with the protrusion 1023 of the barrel 102.

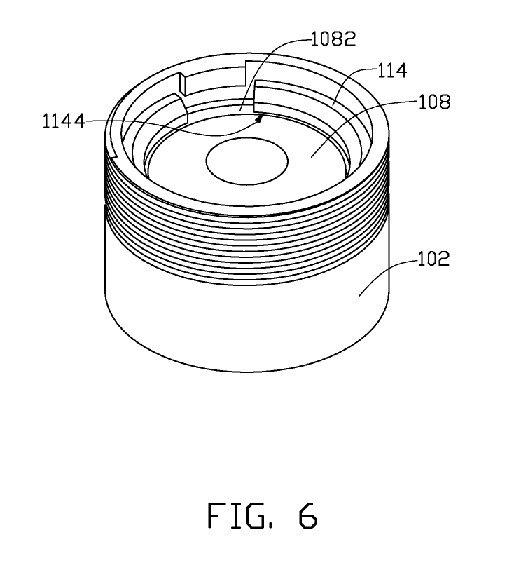

Fourth, referring to FIG. 6, the fastening member 114 is placed into the barrel 102, and the bottom surface 1144 of the fastening member 114 contacts the surface 1082 of the third lens 108.

Lastly, the fastening member 114 is rotated so that the gap 1146 of the fastening member 114 and the protrusion 1023 of the barrel 102 are misaligned with each other. It should be noted that an adhesive can be deposited between the barrel 102 and the fastening member 114.

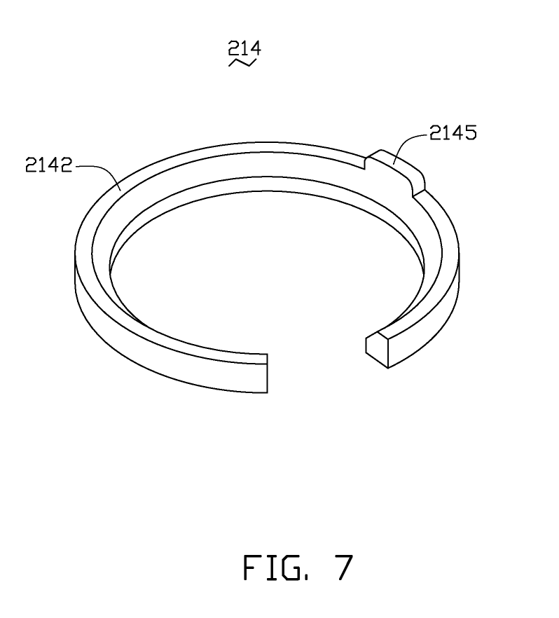

Referring to FIG. 7, a fastening member 214 according to a second embodiment is similar to that of the first embodiment, except that the fastening member 214 further includes a protrusion 2145 formed on the top surface 2142 thereof. In assembly, after the fastening member 214 is placed into the barrel 102, it is very convenient to rotate the fastening member 214 by stirring the protrusion 2145.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope of the appended claims.

What is claimed is:

1. A lens module comprising:
a barrel comprising an inner surface and a protrusion formed on the inner surface thereof;
a lens received in the barrel; and
a generally C-shaped fastening member rotatably received in the barrel and sandwiched between the lens and the protrusion, the fastening member having a gap defined between two distal ends thereof, the protrusion being passable through the gap, the fastening member being rotatable in the barrel relative to the protrusion such that the gap is misaligned with the protrusion.

2. The lens module as claimed in claim 1, wherein the fastening member comprises a top surface and a bottom surface, the bottom surface is in contact with the lens, and the top surface is in contact with the protrusion.

3. The lens module as claimed in claim 2, wherein the fastening member comprises a protrusion formed on the top surface.

4. The lens module as claimed in claim 1, wherein the shape and the size of the gap conform with the protrusion.

5. The lens module as claimed in claim 1, wherein the size of the gap is larger than or equal to that of the protrusion.

6. The lens module as claimed in claim 1, wherein the barrel comprises a supporting portion therein, and the lens is in contact with the supporting portion.
